(19) United States
(12) Patent Application Publication
(10) Pub. No.: US 2013/0318487 A1
(43) Pub. Date: Nov. 28, 2013

(54) Programmable Circuit Characteristics Analysis

(71) Applicant: Mentor Graphics Corporation, Wilsonville, OR (US)

(72) Inventors: Gregory P. Hackney, West Linn, OR (US); Mark E. Hofmann, Portland, OR (US); Ziyang Lu, Camas, WA (US); Dina Medhat, Cairo (EG)

(73) Assignee: Mentor Graphics Corporation, Wilsonville, OR (US)

(21) Appl. No.: 13/901,506

(22) Filed: May 23, 2013

Related U.S. Application Data
(60) Provisional application No. 61/650,954, filed on May 23, 2012.

(51) Int. Cl. G06F 17/50

(52) U.S. Cl. CPC G06F 17/5022
USPC 716/106

(57) ABSTRACT

Techniques for analysis of an electrical circuit design are described, which techniques employ two phases: an initialization phase, and a check phase. During the initialization phase, a circuit design is examined to determine the predicted operating characteristics at various nodes within the design. If the design is hierarchically arranged, then the design is analyzed in a way that preserves its hierarchy. During the check phase, various implementations of the invention will check the determined operating characteristic values to see if they indicate that one or more design rules have been violated. A user may specify or “program” aspects of the analysis, both for the initialization phase and the check phase.

### RELATED APPLICATIONS

This application claims priority under 35 U.S.C. §119 to U.S. Provisional Patent Application No. 61/650,954, filed on May 23, 2012, entitled “Programmable Circuit Characteristics Analysis,” and naming Gregory P. Hackney et al. as inventors, which application is incorporated entirely herein by reference.

### TECHNICAL FIELD

The present invention is directed the analysis of electrical characteristics of a circuit design. Various implementations of the invention may be particularly useful for determining the expected values of voltages at different nodes throughout a circuit design.

### BACKGROUND

Electrical devices, such as integrated microcircuits, are used in a variety of products, from automobiles to microwaves to personal computers. Designing and fabricating electrical devices typically involves many steps, known as a “design flow.” The particular steps of a design flow often are dependent upon the type of electrical device, its complexity, the design team, and the electrical device manufacturer or foundry that will manufacture the electrical device. For complex electrical devices, software and hardware “tools” are used to verify the design for the electrical device at various stages of the design flow by running software simulators and/or hardware emulators, and errors in the design are corrected or the design is otherwise improved.

Several steps are common to most design flows for integrated microcircuits. Initially, the specification for the new circuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that it will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This device design generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the desired functions. This analysis is sometimes referred to as “formal verification.”

Once the relationships between circuit devices have been established, the design is again transformed, this time into a physical design that describes specific geometric elements. This type of design often is referred to as a “layout” design. The geometric elements, which typically are polygons, define the shapes that will be created in various materials to manufacture the circuit. Typically, a designer will select groups of geometric elements representing circuit device components (e.g., contacts, gates, etc.) and place them in a design area. These groups of geometric elements may be custom designed, selected from a library of previously-created designs, or some combination of both. Lines are then routed between the geometric elements, which will form the wiring used to interconnect the electronic devices. Layout tools (often referred to as “place and route” tools) are commonly used for both of these tasks.

With a layout design, each physical layer of the circuit will have a corresponding layer representation in the design, and the geometric elements described in a layer representation will define the relative locations of the circuit device components that will make up a circuit device. Thus, the geometric elements in the representation of an implant layer will define the doped regions, while the geometric elements in the representation of a metal layer will define the locations in a metal layer where conductive wires will be formed to connect the circuit devices. Typically, a designer will perform a number of analyses on the layout design data. For example, with integrated circuits, the layout design may be analyzed to confirm that it accurately represents the circuit devices and their relationships as described in the device design. The layout design also may be analyzed to confirm that it complies with various design requirements, such as minimum spacings between geometric elements. Still further, the layout design may be modified to include the use of redundant geometric elements or the addition of corrective features to various geometric elements, to counteract limitations in the manufacturing process, etc.

After the layout design has been finalized, it is converted into a format that can be employed by a mask or reticle writing tool to create a mask or reticle for use in a photolithographic manufacturing process. The written masks or reticles then can be used in a photolithographic process to expose selected areas of a wafer to light or other radiation in order to produce the desired integrated microdevice structures on the wafer.

### BRIEF SUMMARY

Aspects of the invention relate to the analysis of an electrical circuit design, to predict the operating characteristics of an electrical circuit manufactured from the circuit design. Various implementations of the invention may employ two phases: an initialization phase, and a check phase.

During the initialization phase, a circuit design is examined to determine the predicted operating characteristics at various nodes within the design. With various implementations of the invention, if the design is hierarchically arranged, then the design is analyzed in a way that preserves its hierarchy. More particularly, input operating characteristic values are propagated in a hierarchical manner, from parent cells to child cells, until operating characteristic values are sufficiently populated throughout the nodes in the circuit design. With some implementations of the invention, the operating characteristic values will be voltage values. Still other implementations of the invention may alternately or additionally determine other operating characteristic values, however, such as current or power operating characteristic values.

During the check phase, various implementations of the invention will check the determined operating characteristic values to see if they indicate that one or more design rules have been violated. For example, if the operating characteristic values are voltage values, some examples of the invention can check whether the expected voltage differential across a device in the design will exceed the operating parameters of that device. The circuit's designer can then modify the design to ensure that, during the actual operation of an electrical circuit manufactured from the design, the maximum tolerable voltage differential for the device will not be exceeded.

Various implementations of the invention may allow a user to specify or “program” aspects of the analysis, both for the initialization phase and the check phase. For example, some embodiments of the invention may allow a user to specify that a node in the circuit design has a particular operating characteristic value for the initialization phase. Some examples of the invention may alternately or additionally allow a user to specify how operating characteristic values will be propagated during the initialization phase. If the operating characteristic values are voltage values, then various implementations of the invention may propagate these voltage values by assuming that there will be no voltage drop across transistors in the design. Some implementations of the invention may allow a user to override this assumption, however, by programming the use of a specific voltage drop across all transistors, specific types of transistors, or even one or more transistors at a specific location in the design. With regard to the check phase, various implementations of the invention will allow a user to program a specific check to be performed on the design using the determined operating characteristic values. Thus, if the operating characteristic values are voltage values, these examples of the invention may allow a user to specific a maximum voltage differential across a device. During the check phase, the determined voltage values are to determine if the expected voltage differential across the device will exceed the specified maximum. If it does, then a violation of the rule is indicated to the user.

### BRIEF DESCRIPTION OF THE DRAWINGS

FIGS. 1 and 2 illustrate a generic example of a programmable computer system that can be used to implement various embodiments of the invention.

FIG. 3 illustrates an example of a circuit analysis tool that may be used to implement a programmable circuit characteristic analysis process according to various embodiments of the invention.

FIG. 4 illustrates a flowchart showing operations that may be implemented in a programmable circuit characteristic analysis process according to various embodiments of the invention.

### DETAILED DESCRIPTION

Illustrative Operating Environment

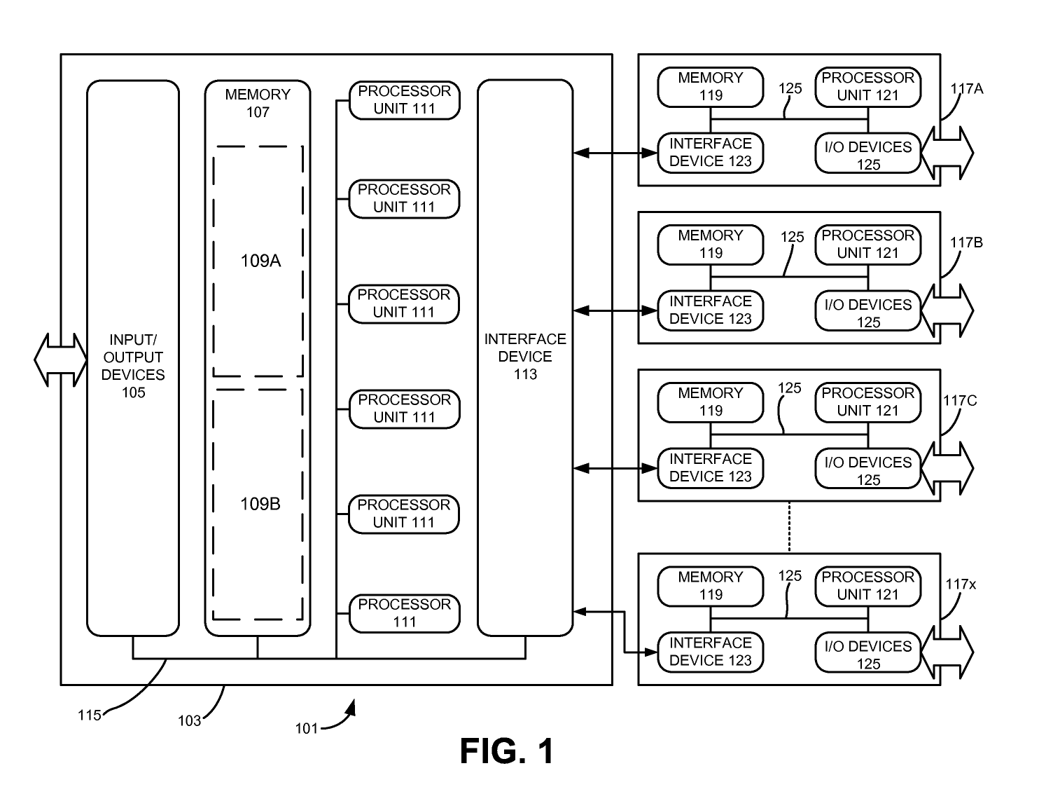

The execution of various electronic design automation processes according to embodiments of the invention may be implemented using computer-executable software instructions executed by one or more programmable computing devices. Because these embodiments of the invention may be implemented using software instructions, the components and operation of a generic programmable computer system on which various embodiments of the invention may be employed will first be described. Further, because of the complexity of some electronic design automation processes and the large size of many circuit designs, various electronic design automation tools are configured to operate on a computing system capable of simultaneously running multiple processing threads. The components and operation of a computer network having a host or master computer and one or more remote or servant computers therefore will be described with reference to FIG. 1. This operating environment is only one example of a suitable operating environment, however, and is not intended to suggest any limitation as to the scope of use or functionality of the invention.

In FIG. 1, the computer network 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media will be made up of one or more storage devices for storing data in a non-transitory manner including, for example, microcircuit memory devices such as read-write memory (RAM) devices, read-only memory (ROM) devices, electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information.

As will be discussed in detail below, the master computer 103 executes software instructions for performing one or more operations according to various examples of the invention. Accordingly, the memory 107 is made up of one or more storage devices for storing software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Core™ or Xeon® microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

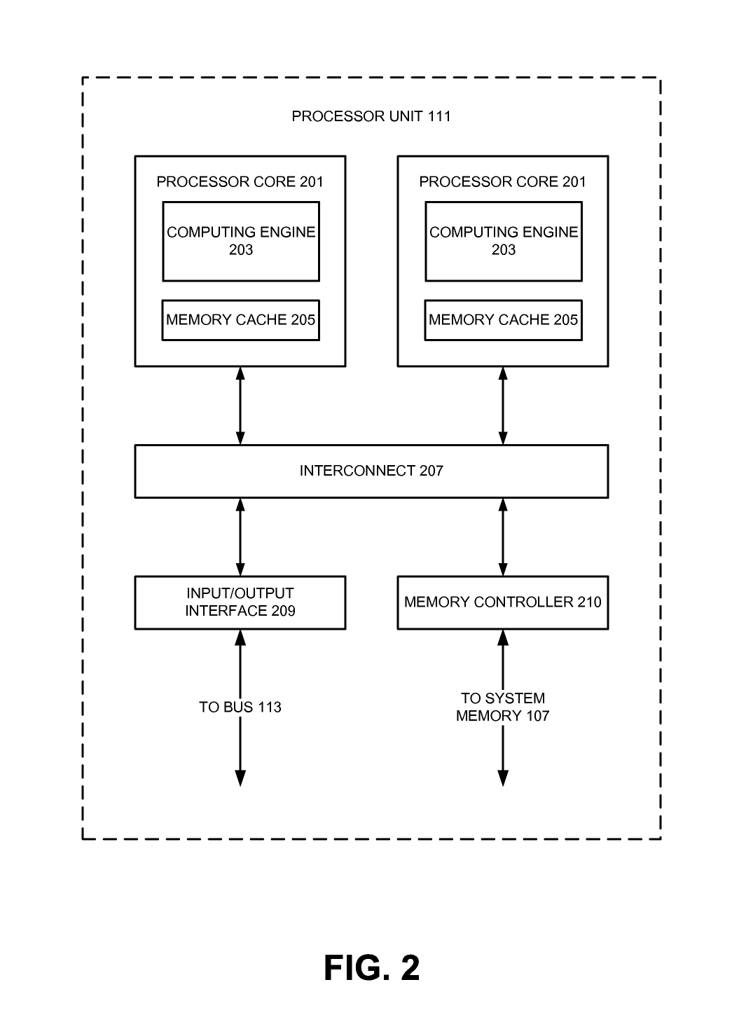

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interface 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. It also should be appreciated that, with some implementations, a multi-core processor unit 111 can be used in lieu of multiple, separate processor units 111. For example, rather than employing six separate processor units 111, an alternate implementation of the invention may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the servant computers 117A, 117B, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the servant computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each servant computer 117 may include a memory 119, a processor unit 121, an interface device 123, and, optionally, one more input/output devices 125 connected together by a system bus 127. As with the master computer 103, the optional input/output devices 125 for the servant computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon® microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. For example, with some implementations of the invention, one or more of the processor units 121 may be a Cell processor. The memory 119 then may be implemented using any combination of data storage devices like the memory 107 discussed above. Like the interface device 113, the interface devices 123 allow the servant computers 117 to communicate with the master computer 103 over the communication interface.

In the illustrated example, the master computer 103 is a multi-processor unit computer with multiple processor units 111, while each servant computer 117 has a single processor unit 121. It should be noted, however, that alternate implementations of the invention may employ a master computer having single processor unit 111. Further, one or more of the servant computers 117 may have multiple processor units 121, depending upon their intended use, as previously discussed. Also, while only a single interface device 113 or 123 is illustrated for both the master computer 103 and the servant computers, it should be noted that, with alternate embodiments of the invention, either the computer 103, one or more of the servant computers 117, or some combination of both may use two or more different interface devices 113 or 123 for communicating over multiple communication interfaces.

With various examples of the invention, the master computer 103 may be connected to one or more external data storage devices. These external data storage devices may be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the invention, one or more of the servant computers 117 may alternately or additionally be connected to one or more external data storage devices. Typically, these external data storage devices will include data storage devices that also are connected to the master computer 103, but they also may be different from any data storage devices accessible by the master computer 103.

It also should be appreciated that the description of the computer network illustrated in FIG. 1 and FIG. 2 is provided as an example only, and it not intended to suggest any limitation as to the scope of use or functionality of alternate embodiments of the invention.

Hierarchical Arrangement Of Design Data

The design of a complex electrical device, such as an integrated circuit, may include the interconnection of millions of transistors, resistors, capacitors, or other electrical structures into logic circuits, memory circuits, programmable field arrays, and other circuit devices. In order to allow a computer to more easily create and analyze these large data structures (and to allow human users to better understand these data structures), they are often hierarchically organized into smaller data structures, typically referred to as “cells.” Thus, for a microprocessor or flash memory design, all of the transistors making up a memory circuit for storing a single bit may be categorized into a single “bit memory” cell. Rather than having to enumerate each transistor individually, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the design data describing other miscellaneous circuitry, such as an input/output circuit for transferring data into and out of each of the bit memory cells. Similarly, the design data describing a 128 kB memory array can then be concisely described as a combination of only 64,000 register cells, together with the design data describing its own miscellaneous circuitry, such as an input/output circuit for transferring data into and out of each of the register cells. Of course, while the above-described example is of design data organized hierarchically based upon circuit structures, circuit design data may alternately or additionally be organized hierarchically according to any desired criteria including, for example, a geographic grid of regular or arbitrary dimensions (e.g., windows), a memory amount available for performing operations on the design data, design element density, etc.

By categorizing microcircuit design data into hierarchical cells, large data structures can be processed more quickly and efficiently. For example, a circuit designer typically will analyze a design to ensure that each circuit feature described in the design complies with design rules specified by the foundry that will manufacture microcircuits from the design. With the above example, instead of having to analyze each feature in the entire 128 kB memory array, a design rule check process can analyze the features in a single bit cell. The results of the check will then be applicable to all of the single bit cells. Once it has confirmed that one instance of the single bit cells complies with the design rules, the design rule check process then can complete the analysis of a register cell simply by analyzing the features of its additional miscellaneous circuitry (which may itself be made of up one or more hierarchical cells). The results of this check will then be applicable to all of the register cells. Once it has confirmed that one instance of the register cells complies with the design rules, the design rule check software application can complete the analysis of the entire 128 kB memory array simply by analyzing the features of the additional miscellaneous circuitry in the memory array. Thus, the analysis of a large data structure can be compressed into the analyses of a relatively small number of cells making up the data structure.

Programmable Analysis Tool

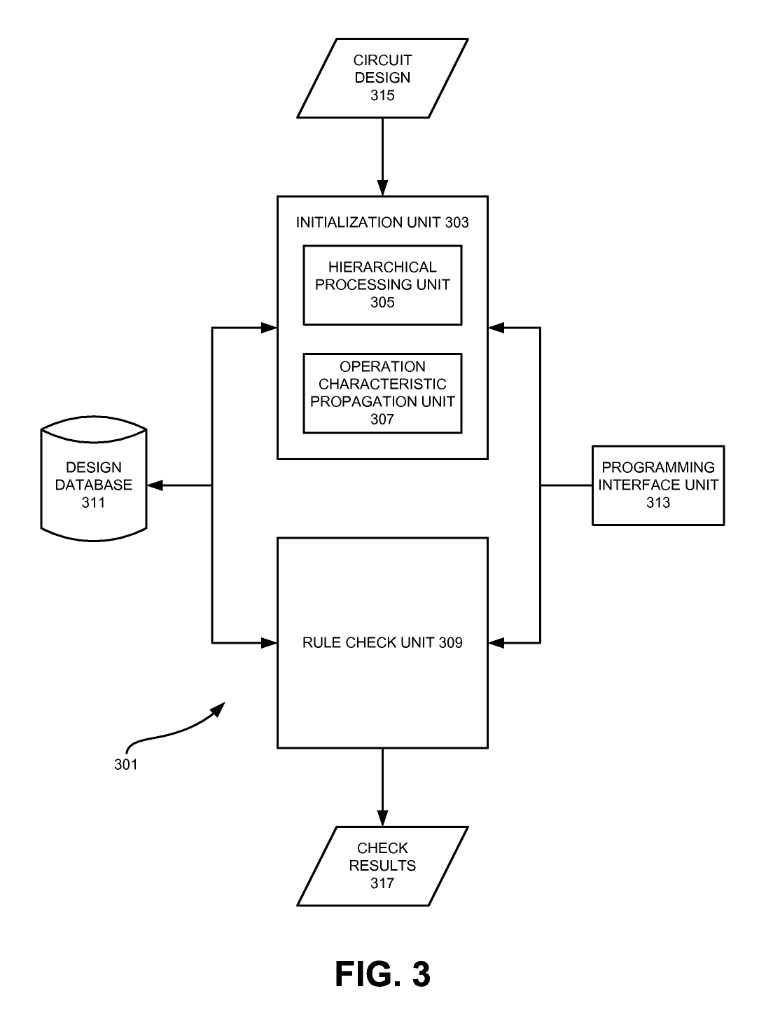

FIG. 3 illustrates a programmable circuit characteristic analysis tool 301 that may be implemented according to various examples of the invention. As seen in this figure, the programmable circuit characteristic analysis tool 301 includes an initialization unit 303. The initialization unit 303 includes a hierarchical processing unit 305 and an operation characteristic propagation unit 307. The programmable circuit characteristic analysis tool 301 also includes a rule check unit 309, a design database 311, and a programming interface unit 313.

As will be discussed in more detail below, the initialization unit 303 performs the initialization phase of a programmable circuit characteristic analysis process according to various embodiments of the invention. During this phase, a circuit design is analyzed to determine the operating characteristic values for various nodes in the design. More particularly, if the design is arranged in a hierarchical structure, the hierarchical processing unit 305 accesses the various cells according to the hierarchical structure of the design. The operation characteristic propagation unit 307 then propagates operating characteristic values within each cell as it is accessed.

It should be appreciated by those of ordinary skill in the art that the operating characteristic values are values that would be produced by an electrical circuit manufactured from the design during operation. With various implementations of the invention, the operating characteristic values can be determined using conventional circuit design analysis techniques. For ease of understanding, various examples of the invention will be described herein with respect to operating characteristic values that are voltage values. It should be appreciated, however, that various embodiments of the invention may analyze any desired type of operating characteristic values, including, for example, current values, power values, or some combination of multiple operating characteristic values.

Also, as used herein, the term “design” is intended to encompass data describing an entire electrical device, such as an entire integrated circuit device. This term also is intended to encompass a smaller group of data describing one or more components of an entire electrical device, however. Still further, the term “design” also is intended to encompass data describing more than one electrical device, such as data to be used to create a mask or reticle for simultaneously forming multiple electrical devices on a single wafer.

Once the initialization unit 303 has determined the operating characteristic values for various nodes in the circuit design, the rule check unit 309 examines those values to determine if the design violates one or more design rules. Both the initialization unit 303 and the rule check unit 309 may employ the design database 311 to store design data and other data employed by the respective units. Similarly, both the initialization unit 303 and the rule check unit 309 may receive programming commands from a user through the programming interface unit 313, as will also be explained in more detail below.

As previously noted, various examples of the invention may be implemented by a multiprocessor computing system, such as the multiprocessor computing system 101 illustrated in FIG. 1. Accordingly, one or more components of each of the initialization unit 303, the hierarchical processing unit 305, the operation characteristic propagation unit 307, the rule check unit 309, and the programming interface unit 313 may be implemented using one or more processors in a multiprocessor computing system's master computer, such as the master computer 103, one or more servant computers in a multiprocessor computing system, such as the servant computers 117, or some combination of both. It also should be appreciated that, while the initialization unit 303, the hierarchical processing unit 305, the operation characteristic propagation unit 307, the rule check unit 309, and the programming interface unit 313 are shown as discrete units in FIG. 3, a single servant computer (or a single processor within a master computer) may be used to implement two or more of these units at different times, or components of two or more of these units at different times. Further, while the initialization unit 303, the hierarchical processing unit 305, the operation characteristic propagation unit 307, the rule check unit 309, and the programming interface unit 313 are shown as discrete units, it should be appreciated that functions of these units can be combined, further divided, or otherwise reorganized as desired.

The design database 311 may be any data storage device that is capable of storing design data and accessible to the programmable circuit characteristic analysis tool 301. For example, the design database 311 may be implemented using a magnetic disk drive, a rewritable optical disk drive, a “punch” type memory device, a holographic memory device, etc. Of course, while a single design database 311 is illustrated in FIG. 3, alternate examples of the invention may employ two or more separate memory storage devices working in concert to form the design database 311. Further, with alternate implementations of the invention, the functionality of the design database 311 may be subdivided among multiple databases as desired.

With various embodiments of the invention, the programmable circuit characteristic analysis tool 301 (or one or more components of the programmable circuit characteristic analysis tool 301) may be implemented using a programmable electrical rule checking system, such as the programmable electrical rule checking systems described in U.S. Provisional Patent Application No. 61/053,576, filed on May 15, 2008, entitled “Programmable Electrical Rule Checking,” and naming Fedor Pikus et al. as inventors, U.S. patent application Ser. No. 12/474,240, filed on May 15, 2009, entitled “Programmable Electrical Rule Checking,” and naming Fedor Pikus et al. as inventors, in U.S. Provisional Patent Application No. 61/348,209, filed on May 25, 2010, entitled “Logic Driven Layout Verification,” and naming Fedor Pikus et al. as inventors, in U.S. patent application Ser. No. 12/952,196, filed on Nov. 22, 2010, entitled “Logic Driven Layout Verification,” and naming Fedor Pikus et al. as inventors, and in U.S. patent application Ser. No. 13/017,788, filed on Jan. 31, 2011, entitled “Logic Driven Layout Verification,” and naming Fedor Pikus et al. as inventors, each of which applications is incorporated entirely herein by reference.

Programmable Analysis Method

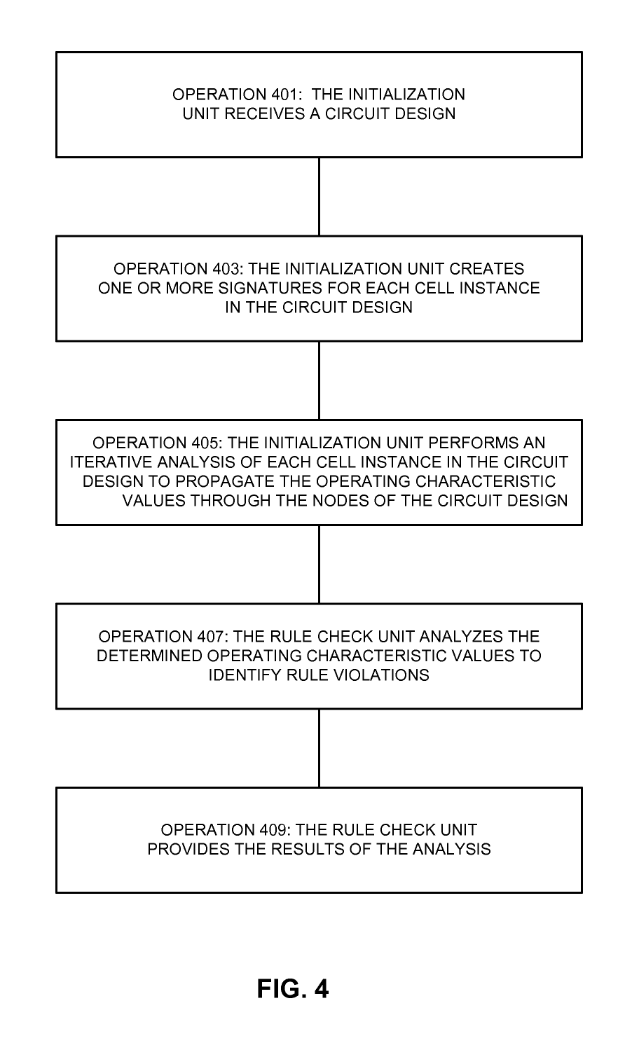

Various techniques for performing a programmable analysis of a circuit design according to various examples of the invention will now be described with respect to FIG. 4. For ease of understanding, the techniques illustrated in FIG. 4 will be described with reference to examples of the generic programmable circuit characteristic analysis tool 301 shown in FIG. 3. It should be appreciated, however, that various techniques for performing a programmable analysis of a circuit design according to various examples of the invention may be performed without using the generic programmable circuit characteristic analysis tool 301 shown in FIG. 3. Similarly, the generic programmable circuit characteristic analysis tool 301 shown in FIG. 3 may be employed to implement techniques for performing a programmable analysis of a circuit design according to various examples of the invention other than those shown in FIG. 4.

Turning now to FIG. 4, in operation 401, a circuit design 315 is provided to the initialization unit 303. With various examples of the invention, the circuit design 315 can be provided in a netlist form. Further, the circuit design 315 can be provided using any desired data format, such as a SPICE netlist. As noted above, if the circuit design 315 describes a complex electrical device, such as a complex integrated circuit device, the design data in the circuit design 315 may be organized in a hierarchical arrangement of cells. With various examples of the invention, the hierarchy of the circuit design 315 will be preserved when it is provided to the initialization unit 303.

Next, in operation 403, the initialization unit 303 creates one or more signatures for each cell instance in the circuit design 315. According to various examples of the invention, each cell instance will have a signature including the input values for the cell and the output values for the cell. As will be appreciated by those of ordinary skill in the art, an input value or output value for a cell typically will be a signal value or a power/ground supply value. Each cell instance also will have a signature including the context of that instance of the cell, i.e., the relationship of that cell instance to a particular parent cell. As should be appreciated by those of ordinary skill in the art, the signals and context will reflect logical aspects of the circuit design 315, not physical aspects of the circuit design 315.

With various examples of the invention, each cell instance may additionally have a cell type reflecting the function of the cell, such as a power supply type, a ground type, an input/output pad type (e.g., for cells that include an input or output pad for relaying signals to or from outside of the circuit). Still further, some implementations may provide each instance with a more specific type, such as a specific voltage (e.g., 3.5 Volts) carried by the cell instance. With these implementations, a cell instance may have a signature that includes the cell type. Various techniques for generating signatures that may be employed by various examples of the invention are discussed in more detail in U.S. Provisional Patent Application No. 61/632,818, filed on Aug. 22, 2011, entitled “Virtual Flat Traversal Of A Hierarchical Circuit Design,” and naming Ziyang Lu and Phillip A. Brooks as inventors, in U.S. patent application Ser. No. 12/868,717, filed on Aug. 25, 2010, entitled “Virtual Flat Traversal Of A Hierarchical Circuit Design,” and naming Ziyang Lu and Phillip A. Brooks as inventors, and in U.S. Patent application Ser. No. 13/592,304, filed on Aug. 22, 2012, entitled “Virtual Flat Traversal Of A Hierarchical Circuit Design,” and naming Ziyang Lu et al. as inventors, each of which applications is incorporated entirely herein by reference. It should be appreciated by those of ordinary skill in the art that these cell instance signatures allow the programmable circuit characteristic analysis tool 301 to quickly determine when two or more cells instances are identical, reducing the time and resources needed to process duplicative cell instances.

In operation 405, the initialization unit 303 performs an iterative analysis of each cell instance in the circuit design 315, propagating the operating characteristic values through the various nodes of the circuit design 315 based upon input operating characteristic values. For example, if the operating characteristic values are voltage values, then the circuit design 315 will typically specify particular voltage values to be applied to the circuit at its power supply input pads. These specified voltage values are then provided used as initial condition operating characteristic values in the operation 405. Similarly, the circuit design 315 may specify particular input and/or output signal values that will be used by the initialization unit 303 as initial condition operating characteristic values.

While the circuit design 315 may specify multiple power voltage values for different voltage domains, these input voltage operating characteristic values typically will only be provided for top level cells having power supply pads. Similarly, if the circuit design 315 specifies one or more signal voltage values, these also typically will only be provided for top level cells having input/output pads. Accordingly, the initial condition operating characteristic values will usually be specified for only a small number of nodes in the circuit design 315.

During operation 405, the hierarchical processing unit 305 accesses each cell instance based upon the hierarchy of the design. For example, the hierarchical processing unit 305 may start by accessing the top level cell in the circuit design 315, and then accessing each of its child cells in sequence. For each accessed child cell, its child cells also may be accessed in sequence, and so forth until all of the cells of the circuit design 315 have been accessed. Different techniques that may be employed by various embodiments of the invention for accessing and processing cells in a hierarchical manner are described in U.S. Provisional patent application No. 61/632,818, filed on Aug. 22, 2011, entitled “Virtual Flat Traversal Of A Hierarchical Circuit Design,” and naming Ziyang Lu and Phillip A. Brooks as inventors, and in U.S. Provisional patent application No. 12/868,717, filed on Aug. 25, 2010, entitled “Virtual Flat Traversal Of A Hierarchical Circuit Design,” and naming Ziyang Lu and Phillip A. Brooks as inventors, both of which applications are incorporated entirely herein by reference.

As each cell is accessed, the operation characteristic propagation unit 307 employs the initial condition operating characteristic values to propagate operating characteristic values throughout the cell to the extent possible. For example, if the initial condition operating characteristic values indicate that a particular voltage value is applied to the drain of a transistor, an appropriate voltage value is propagated to the source of that transistor based upon the initial condition voltage value. As the operation characteristic propagation unit 307 determines the operating characteristic value for a node in the accessed cell instance, that value is then employed as relevant to determine the operating characteristic values for the other nodes in the cell. Further, as the operation characteristic propagation unit 307 accesses child cells, operating characteristic values determined for nodes in the parent cell are employed as relevant to determine the operating characteristic values for the nodes in the child cell.

As discussed above, with various implementations of the invention, the operating characteristic values can be determined for propagation using conventional circuit design analysis techniques. Some examples of the invention may employ various shortcut techniques as desired, however. For example, with some implementations of the invention the operation characteristic propagation unit 307 may assume that there is no voltage drop over a transistor.

In many situations, the operating characteristic values for many of the nodes in the circuit design 315 can be immediately determined from the initial condition operating characteristic values. With some circuit configurations, however, an operating characteristic value for a node cannot be determined until the operating characteristic value for another node is previously determined. For example, with various multiplexer structures, the voltage at the output node of the multiplexer may not be determinable until all the voltages for all of the input nodes have been determined. As previously noted, cell signatures may be employed to identify identical cell instances and expedite the propagation process.

Accordingly, operation 405 is iteratively repeated, with the operating characteristic values determined for nodes in a previous iteration of operation 405 being employed to determine the operating characteristic values of undetermined nodes in the subsequent iteration of operation 405. More particularly, the operation 405 is iteratively repeated until the initialization phase is completed. With various examples of the invention, the initialization unit 303 may conclude that the initialization phase is completed when all of the nodes in the circuit design 315 have been assigned an operating characteristic value. Some implementations of the invention may alternately or additionally conclude that the initialization phase is completed when operation 405 has been iterated a specific number of times. Still further, some implementations of the invention may track the operating characteristic values determined by the iterations of the operation 405. These implementations may conclude that the initialization phase is completed when the determined operating characteristic values no longer change, or when one or more of the operating characteristic values that do continue to change only oscillate between two different amounts.

With various examples of the invention, the programming interface unit 313 allows a user, such as a designer for the circuit design 315, to program various aspects of the initialization phase. For example, some implementations of the invention may allow a user to specify one or more initial condition operating characteristic values in addition to (or instead of) those initially specified in the circuit design 315. This program feature can be employed before an iteration of operation 405 is started, to override an initial condition operating characteristic value for a node specified in the netlist for the circuit design 315. This program feature also can be employed after one or more iterations of the operation 405 have been completed, to assign an operating characteristic value to a node for which one cannot otherwise be determined.

A user may employ the programmable features of various examples of the invention in two modes: a vectored mode and a vectorless mode. With the vectored mode, the user can specify particular initial condition operating characteristic values, to determine the voltages at the output and at internal nodes given specific input conditions. For example, in addition to the voltage supply values that may be specified in the circuit design 315, a user may additionally specify the values of one or more data signals applied to input/output pads of the circuit design 315. The user can then determine what operating characteristic values will be generated for the nodes of the circuit design 315 based upon the specified initial condition operating characteristic values. In the vectorless mode, the user may provide as little initial condition information as possible. For example, the user may only provide (or allow to be provided) the voltage values to be applied to power supply pads, but no signal voltage values.

Various examples of the invention may alternately or additionally allow a user to specify one or more parameters for propagating the operating characteristic values. For example, as noted above, with some implementations of the invention the operation characteristic propagation unit 307 may assume that there is no voltage drop across a transistor. By using the propagation parameter feature, however, a user can change this default assumption to instead specify that the operation characteristic propagation unit 307 employ a particular voltage drop across a transistor. As will be appreciated by those of ordinary skill in the art, this feature allows a user to take into account real-world variables without creating calculation-intensive models.

Implementations of the invention may allow a user to program a propagation parameter according to a variety of criteria. For example, some implementations may allow the user to specify a propagation parameter corresponding to a defined device pattern. The pattern may describe a circuit device such as, for example, a voltage level shifter. As will be appreciated by those of ordinary skill in the art, it may normally be difficult to automatically determine the propagation of a voltage value through a voltage level shifter. By specifying a propagation parameter for level shifters, however, a user can ensure that a voltage values is correctly propagated through a level shifter. When the operation characteristic propagation unit 307 examines the devices in a cell instance, it will compare those devices with the specified device patterns. When it identifies a device (or combination of devices) matching a pattern, it will apply the corresponding propagation parameter to that device or combination of devices. Still other implementations of the invention may alternately or additionally allow a user to specify a propagation parameter for a class of devices, devices in a particular cell, and/or devices at specific locations in the circuit design 315.

After the initialization unit 303 has determined operating characteristic values for nodes in the circuit design 315, the rule check unit 309 analyzes those operating characteristic values during the check phase in operation 407. With various examples of the invention, the rule check unit 309 will analyze the operating characteristic values based upon previously determined rules. For example, the rule check unit 309 may identify a voltage drop across a device in the circuit design 315 that exceeds the maximum voltage differential for that device. The rule check unit 309 also may identify nodes without an assigned operating characteristic value, which suggests that the node was properly connected in the circuit design 315.

With various examples of the invention, a user may employ the programming interface unit 313 to program specific rules to be checked by the rule check unit 309. Again, various implementations of the invention may allow a user to associate a rule with a specific device, a class of devices, or devices (or combinations of devices) matching a device pattern, which also may be created by the user. Various rule check tools are known in the art, and any suitable known rule check tool may be used to implement the rule check unit 309.

After the rule check unit 309 has examined the circuit design 315 and the operating characteristic values determined during the initialization phase to see if the circuit design 315 violates any rules, the rule check unit 309 will provide the results of the analysis in operation 409. The results may be provided in any desired fashion. For example, the results may be displayed on a monitor, printed out onto a written medium, saved in a data storage device, or some combination thereof.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

What is claimed is:

1. A programmable circuit characteristic analysis tool, comprising
an initialization unit configured to determine the operating characteristic values for one or more nodes in a circuit design; and
a rule check unit configured to identify features in the circuit design that violate one or more design rules based upon the determined operating characteristic values.

2. The programmable circuit characteristic analysis tool recited in claim 1, wherein the initialization unit comprises:
a hierarchical processing unit configured to access cells of the circuit design according to a hierarchical structure of the circuit design; and
an operation characteristic propagation unit configured to propagate operating characteristic values within each cell.

3. The programmable circuit characteristic analysis tool recited in claim 2, wherein the operation characteristic propagation unit is further configured to employ one or more propagation parameters to propagate the operating characteristic values.

4. The programmable circuit characteristic analysis tool recited in claim 3, wherein the one or more propagation parameters apply a specified operating characteristic value to one or more designated devices in the circuit design.

5. The programmable circuit characteristic analysis tool recited in claim 4, wherein the operation characteristic propagation unit is further configured to identify the one or more designated devices based upon a defined device pattern.

6. The programmable circuit characteristic analysis tool recited in claim 4, wherein the one or more designated devices are selected from the group consisting of: a specific device, a class of devices, devices in a particular cell, and devices at specific locations in the circuit design.

7. The programmable circuit characteristic analysis tool recited in claim 2, wherein the operation characteristic propagation unit is further configured to propagate the operating characteristic values in a vectored mode.

8. The programmable circuit characteristic analysis tool recited in claim 2, wherein the operation characteristic propagation unit is further configured to propagate the operating characteristic values in a vectorless mode.

9. The programmable circuit characteristic analysis tool recited in claim 1, wherein the rule check unit is further configured to associate a design rule with one or more devices in the circuit design selected from the group consisting of: a specific device, a class of devices, and devices matching a device pattern.

10. A method of analyzing characteristics of a circuit design, comprising:
employing a computer system to access cells of a circuit design according to a hierarchical structure of the circuit design;
employing a computer system to propagate operating characteristic values within each cell; and
employing a computer system to identify features in the circuit design that violate one or more design rules based upon the propagated operating characteristic values.

11. The method of analyzing characteristics of a circuit design recited in claim 10, wherein employing a computer system to propagate operating characteristic values within each cell includes propagating the operating characteristic values according to one or more propagation parameters.

12. The method of analyzing characteristics of a circuit design recited in claim 11, wherein the one or more propagation parameters apply a specified operating characteristic value to one or more designated devices in the circuit design.

13. The method of analyzing characteristics of a circuit design recited in claim 12, further comprising using a computer to identify the one or more designated devices based upon a defined device pattern.

14. The method of analyzing characteristics of a circuit design recited in claim 12, wherein the one or more designated devices are selected from the group consisting of: a specific device, a class of devices, devices in a particular cell, and devices at specific locations in the circuit design.

15. The method of analyzing characteristics of a circuit design recited in claim 10, wherein employing the computer system to propagate operating characteristic values within each cell includes propagating the operating characteristic values in a vectored mode.

16. The method of analyzing characteristics of a circuit design recited in claim 10, wherein employing the computer system to propagate operating characteristic values within each cell includes propagating the operating characteristic values in a vectorless mode.

17. The method of analyzing characteristics of a circuit design recited in claim 10, wherein employing the computer system to identify features in the circuit design that violate one or more design rules includes associating a design rule with one or more devices in the circuit design selected from the group consisting of: a specific device, a class of devices, and devices matching a device pattern.

18. One or more computer-readable storage devices having computer executable instructions stored thereon for causing a computer to perform a method of analyzing characteristics of a circuit design, the method comprising:
accessing cells of a circuit design according to a hierarchical structure of the circuit design;
propagating operating characteristic values within each cell; and
identifying features in the circuit design that violate one or more design rules based upon the propagated operating characteristic values.

19. The one or more computer-readable storage devices recited in claim 18, wherein propagating operating characteristic values within each cell includes propagating the operating characteristic values according to one or more propagation parameters.

20. The one or more computer-readable storage devices recited in claim 18, wherein propagating operating characteristic values within each cell includes propagating the operating characteristic values in a vectored mode.
